(19) United States
(12) Patent Application Publication
(10) Pub. No.: US 2025/0376416 A1
(43) Pub. Date: Dec. 11, 2025

(54) METHOD FOR THERMAL ACTIVATION OF COAL GANGUE AND IN-SITU CARBON FIXATION UTILIZING WASTE HEAT FROM STEEL SLAG

(71) Applicant: Taiyuan University of Technology, Taiyuan City (CN)

(72) Inventors: Yanna HAN, Taiyuan City (CN); Jiahui QIU, Taiyuan City (CN); Guorui FENG, Taiyuan City (CN); Xiaodong CHEN, Taiyuan City (CN); Jinwen BAI, Taiyuan City (CN); Junjie LIAO, Taiyuan City (CN); Shengyu SU, Taiyuan City (CN); Xiran LI, Taiyuan City (CN); Mingzhuang LV, Taiyuan City (CN)

(21) Appl. No.: 19/215,610

(22) Filed: May 22, 2025

(30) Foreign Application Priority Data
Jun. 7, 2024 (CN) 202410737623.0

(51) Int. Cl. C04B 7/44; C04B 7/22; C04B 7/36; C04B 111/00

(52) U.S. Cl. CPC C04B 7/4423; C04B 7/22; C04B 7/367; C04B 2111/00019

(57) ABSTRACT

A method for thermal activation of coal gangue and in-situ carbon fixation utilizing waste heat from steel slag is disclosed. By utilizing waste heat from high-temperature molten steel slag, coal gangue is activated to a high pozzolanic activity utilizing the system temperature of a steel slag hot-steaming device, and meanwhile, the CO₂ released in the thermal activation process is captured utilizing the reaction of steel slag with CO₂ to generate stable carbonates, thus achieving permanent carbon sequestration. The present disclosure effectively uses the heat from the hot steel slag discharged from the steelmaking furnace in such a way that the coal gangue is activated while the steel slag undergoes a carbonation reaction, resulting in an increased heat recovery rate during the cooling process of the steel slag.

### CROSS-REFERENCE TO RELATED APPLICATION

This patent application claims the benefit and priority of Chinese Patent Application No. 2024107376230 filed with the China National Intellectual Property Administration on Jun. 7, 2024, the disclosure of which is incorporated by reference herein in its entirety as part of the present application.

### TECHNICAL FIELD

The present disclosure relates to a method for thermal activation of coal gangue and in-situ carbon fixation utilizing waste heat from steel slag, which belongs to the technical field of integrated solid waste utilization for collaborative energy saving and emission reduction.

### BACKGROUND

Coal gangue, a product of coal mining and coal washing and processing processes of coal preparation plants, is a type of mining solid waste, the main chemical composition of which includes SiO₂ (51%-65%) and Al₂O₃ (16%-36%), with small amounts of Fe₂O₃, CaO, MgO, TiO₂, P₂O₃, K₂O, Na₂O, and V₂O₃. However, after thermal activation, the stable mineral crystal structure contained in coal gangue can be effectively decomposed, and at the same time, the residual coal content decreases, and the activity increases. YUAN Meijuan et al. (YUAN Meijuan, FAN Panpan, BAO Weiren, et al., Effect of calcination temperature and atmosphere on pozzolanic activity and carbon fixation of flotation tailings [J]. Journal of China Coal Society, 2023, 48 (S1): 314-324.) found that the activity of coal gangue is the best after thermal activation at 650-750° C. under atmospheres with air and various CO₂ concentrations, meeting the requirements of GB/T2847 “Pozzolanic Materials Used for Cement Production”, and the coal gangue at this time can be directly mixed with cement as a building material. However, during the thermal activation process, residual coal in coal gangue is converted to CO₂ and released into the atmosphere. How to improve the activity of coal gangue while reducing or even avoiding carbon emissions is an important prerequisite for the resource utilization of coal gangue.

Steel slag is an inevitable product of the steelmaking process, with an output of approximately 10%-15% of crude steel production. With the steady growth of steel production, China's steel slag output reached 164 million tons by 2021. ZHANG Shufan et al. (ZHANG Shufan, CHENG Xingxing, WANG Luyuan, et al. Research on Carbon Sequestration Path of Steel Slag Carbonation under Carbon Neutralization background [J]. Huadian Technology, 2021, 43 (6): 86-91.) disclosed methods of direct carbon fixation with cold steel slag, indirect carbon fixation with cold steel slag, and direct carbon fixation with hot steel slag, and pointed out that: “The technology of direct carbon fixation with hot steel slag holds significant application potential. It can utilize the high-temperature waste heat of steel slag upon discharge, which reaches around 1500° C., to accelerate the carbon fixation reaction. Simultaneously, it enables the recovery of waste heat from the steel slag, further conserving energy. By integrating steel slag gas quenching technology with steel slag carbon fixation technology, it is possible to achieve steel slag carbon fixation and waste heat recovery simultaneously.” Currently, the high-temperature molten steel slag discharged during the steelmaking process in most steel enterprises reaches a temperature as high as 1450° C.-1650° C. Typically, cooling treatment processes such as hot steaming, hot splashing, and water quenching are used to treat the high-temperature steel slag. However, the waste heat from the molten steel slag as it cools to room temperature is not utilized effectively, which is an issue that deserves our significant attention. Moreover, there is currently a lack of practical experience in utilizing the waste heat generated during the cooling process of steel slag. How to effectively utilize this portion of heat and embark on the path of high-quality energy development in the new era remains a subject that requires our continued attention.

Additionally, the hot steaming treatment of steel slag facilitates the decomposition of the unstable components, namely free calcium oxide (f-CaO) and free magnesium oxide (f-MgO), in the steel slag, mitigates the expansive nature of steel slag, and improves the volume stability of steel slag, thereby facilitating its subsequent utilization in building materials. Furthermore, steel slag contains a significant amount of calcium-based compounds, which exhibit excellent CO₂ capture and sequestration capabilities. Utilizing steel slag for carbonation to capture CO₂ can, on one hand, convert wastes into valuable products, enabling resource recovery and reuse, improving the comprehensive utilization efficiency of wastes and reducing reliance on natural resources, and on the other hand, can reduce the emission of CO₂, mitigating the effects of the greenhouse effect.

In summary, the present disclosure provides a method for thermal activation of coal gangue and in-situ carbon fixation utilizing waste heat from steel slag, which can not only effectively utilize the heat from high-temperature steel slag to activate coal gangue, reduce additional heat input, and achieve energy conservation, but also can use steel slag to capture CO₂ generated during the thermal activation process of coal gangue, reduce carbon emissions, and form environmentally friendly resource utilization.

### SUMMARY

The present disclosure aims to provide a method for thermal activation of coal gangue and in-situ carbon fixation utilizing waste heat from steel slag. By utilizing waste heat from high-temperature molten steel slag, coal gangue is thermally activated and CO₂ generated during the thermal activation process of coal gangue is captured in situ by steel slag through the coupled thermal activation-carbonation effect in a specific device.

In the present disclosure, coal gangue is placed in a self-designed steel slag hot-steaming device and is thermally activated to stimulate the pozzolanic activity thereof using the waste heat from the cooling process of high-temperature molten steel slag, thus improving the resource utilization of coal gangue. Meanwhile, CO₂ generated during the thermal activation of coal gangue is fixed by the calcium-containing substances in the steel slag, thus reducing the carbon emission during the activation process, and the volume stability of the steel slag after hot steaming is improved, which is favorable to the subsequent utilization of the steel slag in building materials.

The present disclosure provides a method for thermal activation of coal gangue and in-situ carbon fixation utilizing waste heat from steel slag. By utilizing waste heat from high-temperature molten steel slag, coal gangue is activated to a high pozzolanic activity in a self-designed steel slag hot-steaming device utilizing the system temperature of the steel slag hot-steaming device, and meanwhile, the CO₂ released in the thermal activation process is captured utilizing the reaction of steel slag with CO₂ to generate stable carbonates, thus achieving permanent carbon sequestration.

The method for thermal activation of coal gangue and in-situ carbon fixation utilizing waste heat from steel slag described above specifically includes the following steps:
step 1: transporting high-temperature liquid steel slag from a converter to a hot-steaming device by a slag pot carrier, and pouring the liquid slag in batches into the steel slag hot-steaming device using a crane;
step 2: crushing and grinding raw coal gangue, and loading the crushed and ground coal gangue into a suspension device;
step 3: placing the suspension device loaded with coal gangue with a certain particle size into the hot-steaming device and covering a hot-steaming lid for a slag hot-steaming treatment for 2-3 h with a reaction temperature of 500-850° C., a pressure of 0.3-0.4 MPa, and spraying devices automatically spraying water, where the coal gangue undergoes a thermal activation reaction, and meanwhile, the steel slag undergoes a carbonation reaction with CO₂, thereby capturing CO₂ generated during the activation process of coal gangue; and
step 4: after the completion of the hot-steaming process, removing the activated material, and scooping out the crushed and cooled steel slag from the hot-steaming device using an excavator and transporting the steel slag to a subsequent iron and slag separation system.

In step 1, the steel slag hot-steaming device is a self-designed hot-steaming device, which has no requirement for the fluidity of steel slag and is suitable for solid, semi-solid, and liquid steel slag. The self-designed steel slag hot-steaming device is a cylindrical tank structure provided with a hot-steaming lid on the top, a suspension device in the middle, and a water drain hole at the bottom; the side wall and bottom of the tank are provided, from the outside to the inside, with a wall body, a high-temperature refractory layer, and a baffle plate, where the wall body is made of reinforced concrete, the high-temperature refractory layer is made of refractory bricks, and the baffle plate is made of a steel plate. The baffle plate at the bottom is designed to be inclined to facilitate the discharge of wastewater, with an inclination angle of 5-20°; and a circular protruding ledge is provided on the baffle plate of the side wall, and the suspension device is placed on the protruding ledge.

Further, the inner center of the suspension device is a semicircular tank made of reinforced concrete, the outer edge of the semicircular tank is uniformly connected to 8 support rods along the circumferential direction, outer ends of the support bars are connected to a circular ring support, and the circular ring support is placed on the protruding ledge; and an end of the suspension device is approximately 80 cm from the top edge of the hot-steaming tank, and the diameter of the semicircular tank for the suspension device is 100 cm.

Further, the hot-steaming lid is provided with automatic spraying devices, an air release device, a safety valve, and an explosion-proof device, where the spraying devices can realize automatic water spraying by using a sensor to sense the temperature within the device and a controller to determine whether to initiate spraying, and the spray devices spray water mist; the air release device is provided to discharge a low-density explosive gas, such as H₂ and CO, generated during the slag hot-steaming process; and the safety valve is provided to ensure the vapor pressure inside the tank and, if necessary, release the vapor pressure by discharging a medium outside the system when the pressure inside the device rises to exceed 0.4 MPa to prevent the pressure of the medium inside the device from exceeding a specified value.

Further, when pouring the steel slag into the hot-steaming device using the crane, after pouring each batch of the steel slag, using the excavator to turn the steel slag over and break up large slag chunks, and at the same time, manually spraying an appropriate amount of water for cooling; and after the slag surface becomes solidified, repeating the operations described above, and stopping the distribution of slag until the distance from the protruding ledge in the hot-steaming device is 45-50 cm, and the temperature of the steel slag is 850-900° C.

In step 2, the raw coal gangue is treated as follows: crushing the raw coal gangue using a jaw crusher and then grinding the raw coal gangue with a ball mill, and sieving the raw coal gangue using a sieve mesh with a pore size of 0.18 mm, where the particle size of the coal gangue after crushing and grinding should be 0.2 mm or less; and further, loading the sieved coal gangue into the suspension device, which is connected and fixed to the upper protruding ledge of the hot-steaming device, to suspend the coal gangue in the upper part of the hot-steaming device; and activating the coal gangue to stimulate the pozzolanic activity thereof utilizing the heat in the hot-steaming device system.

In step 3, when the high-temperature liquid steel slag comes into contact with cold water, the uneven contraction caused by the different expansion coefficients of steel and slag leads to the crushing of large pieces of steel slag. Additionally, the free calcium oxide (f-CaO) and free magnesium oxide (f-MgO) in the steel slag undergo hydration reactions, which result in, on the one hand, volume expansion, causing the further crushing of steel slag, and, on the other hand, can eliminate the instability of the steel slag, facilitating the subsequent comprehensive utilization of the steel slag. The chemical equations are as follows:

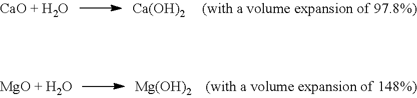

Further, during the thermal activation of coal gangue in an air atmosphere, kaolinite undergoes dehydroxylation and converts into metakaolin (Al₂O₃·2SiO₂), which then decomposes into amorphous SiO₂ and Al₂O₃. These amorphous SiO₂ and Al₂O₃ are the key factors determining the reactivity of coal gangue. The reaction equations are as follows:

Al₂O₃·2SiO₂·H₂O→Al₂O₃·2SiO₂+H₂O

Al₂O₃·2SiO₂→Al₂O₃+2SiO₂

Further, the calcium-based compounds in the steel slag undergo carbonation reactions to form CaCO₃, thereby fixing the CO₂ generated during the activation process of coal gangue into carbonates. Simultaneously, some of the calcium present in the form of silicates undergoes a carbonation reaction to produce reactive SiO₂. The chemical equations are as follows:

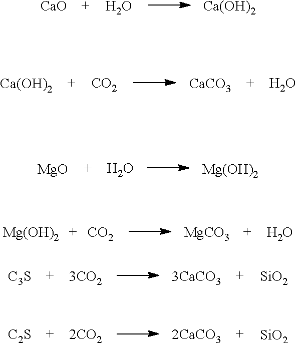

Further, the water spraying procedures of the automatic spraying devices during hot steaming are as follows: spraying water for 0.5 h and then stopping spraying for 1 h, and continuing to spray water for 0.5 h and then stopping spraying for 1.5 h, wherein a water spraying pressure is 0.25-0.35 MPa, and a flow rate is 15-30 m³/h.

In step 4, in the treated steel slag, f-CaO is less than 3%, and the content of particles smaller than 20 mm reaches 60% or more.

The present disclosure has the following beneficial effects.
(1) The heat from the hot steel slag discharged from the steelmaking furnace is effectively used in such a way that the coal gangue is activated while the steel slag undergoes a carbonation reaction. This results in an increased heat recovery rate during the cooling process of the steel slag and further strengthens energy conservation and improves energy efficiency, thus providing a new approach to overcoming resource and environmental constraints and promoting high-quality development.
(2) Through the coupled thermal activation-carbonation effect, CO₂ generated during the activation process of coal gangue is captured by steel slag, which realizes a synergistic effect of coal gangue-steel slag activation and carbon fixation, providing a new idea for the utilization of coal-based solid waste.
(3) Highly reactive pozzolanic materials are prepared utilizing coal gangue; moreover, the stability of steel slag is improved, thus facilitating the subsequent utilization of steel slag in building materials and increasing the resource utilization rate of steel slag. This not only achieves the goal of green resource utilization but also expands the pathways for the utilization of such solid waste resources.
(4) The amount of cooling water used in the cooling process of steel slag is reduced. Since the carbonation reaction of steel slag absorbs heat from the surrounding environment, causing the system temperature of the hot-steaming device in the present process to drop more rapidly, the amount of water required in the cooling stage of steel slag is relatively reduced, thereby achieving the goal of resource conservation.

### BRIEF DESCRIPTION OF THE DRAWINGS

FIG. 1 shows a flow diagram of the process according to the present disclosure;

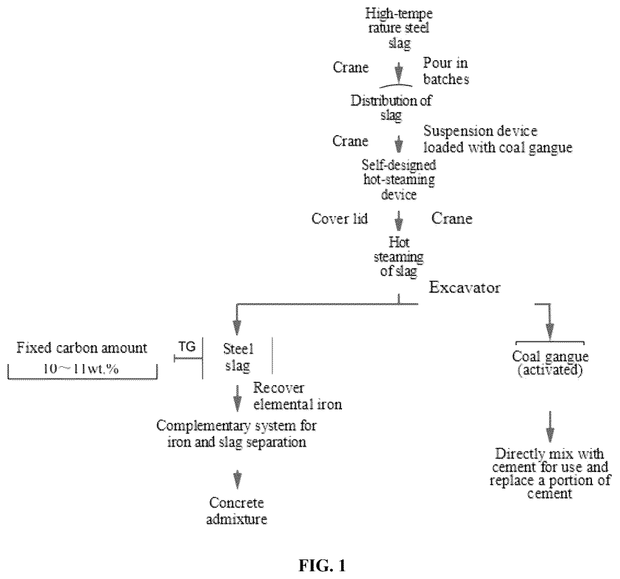

FIG. 2 shows a schematic diagram of the self-designed hot-steaming device of the present disclosure;

FIG. 3 shows a cross-sectional view along line A-A in FIG. 2;

FIG. 4 shows a graph illustrating the compressive strength (a) of thermally activated coal gangue-cement concretion bodies;

FIG. 5 shows a graph illustrating the compressive strength (b) of thermally activated coal gangue-cement concretion bodies;

FIG. 6 shows a TG-DTG graph of a steel slag sample after carbon fixation (a);

FIG. 7 shows a TG-DTG graph of a steel slag sample after carbon fixation (b);

FIG. 8 shows an XRD spectrum of coal gangue after thermal activation at various temperatures under an air atmosphere; and

FIG. 9 shows an FTIR spectrum of coal gangue after thermal activation at various temperatures under an air atmosphere.

In the figures: 1—wall body; 2—high-temperature refractory layer; 3—baffle plate; 4—protruding ledge; 5—explosion-proof device; 6—safety valve; 7—air release device; 8—hot-steaming lid; 9—spraying device; 10—water sealing groove; 11—suspension device; 12—water drain hole.

### DETAILED DESCRIPTION OF THE EMBODIMENTS

The present disclosure is further illustrated by way of example below but is not limited to the following examples.

The present disclosure provides a method for thermal activation of coal gangue and in-situ carbon fixation utilizing waste heat from steel slag. By utilizing waste heat from high-temperature molten steel slag, coal gangue is activated to a high pozzolanic activity in a self-designed steel slag hot-steaming device utilizing the system temperature of the steel slag hot-steaming device, and meanwhile, the CO₂ released in the thermal activation process is captured utilizing the reaction of steel slag with CO₂ to generate stable carbonates, thus achieving permanent carbon sequestration.

The method for thermal activation of coal gangue and in-situ carbon fixation utilizing waste heat from steel slag described above specifically includes the following steps:
step 1: transporting high-temperature liquid steel slag from a converter to a hot-steaming device by a slag pot carrier, and pouring the liquid slag in batches into the steel slag hot-steaming device using a crane;
step 2: crushing and grinding raw coal gangue, and loading the crushed and ground coal gangue into a suspension device;
step 3: placing the suspension device loaded with coal gangue with a certain particle size into the hot-steaming device and covering a hot-steaming lid for a slag hot-steaming treatment for 2-3 h with a reaction temperature of 500-850° C., a pressure of 0.3-0.4 MPa, and spraying devices automatically spraying water, where the coal gangue undergoes a thermal activation reaction, and meanwhile, the steel slag undergoes a carbonation reaction with CO₂, thereby capturing CO₂ generated during the activation process of coal gangue; and
step 4: after the completion of the hot-steaming process, removing the activated material, and scooping out the crushed and cooled steel slag from the hot-steaming device using an excavator and transporting the steel slag to a subsequent for iron and slag separation system.

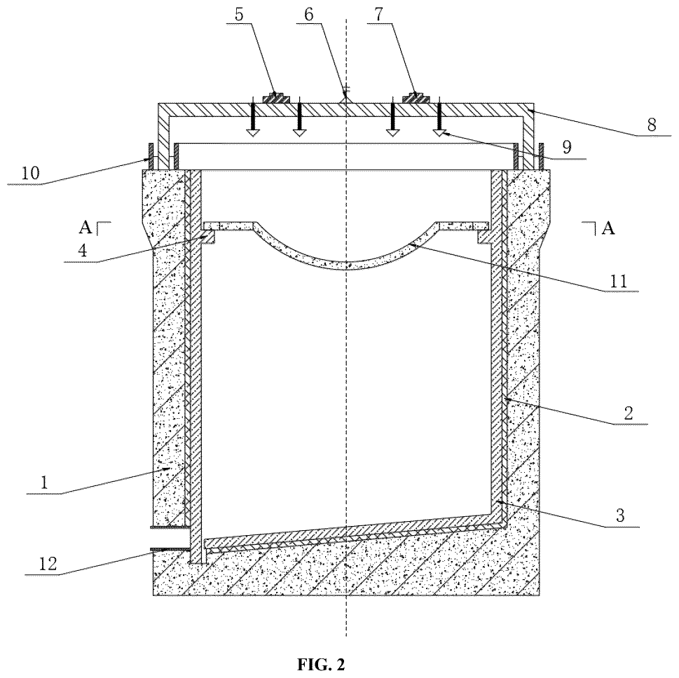

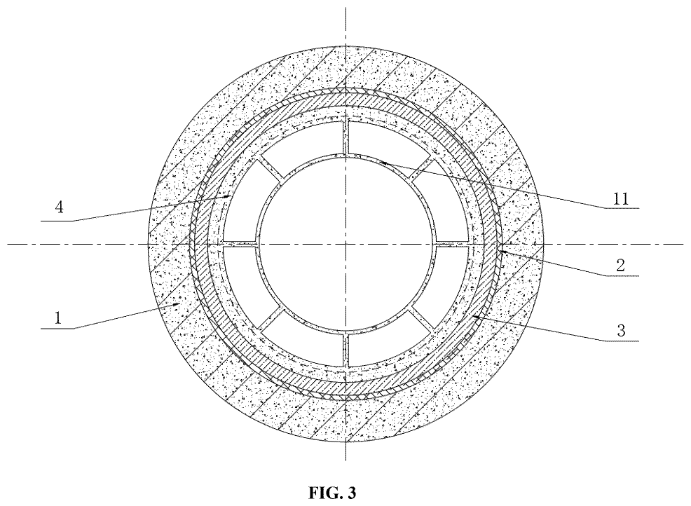

The steel slag hot-steaming device provided by the present disclosure is a self-designed hot-steaming device. As shown in FIGS. 2 and 3, both the side wall and the bottom of the device consist of three parts, from the outside to the inside, including a wall body 1, a high-temperature refractory layer 2, and a baffle plate 3. Moreover, the device has no requirement for the fluidity of steel slag and is suitable for solid, semi-solid, and liquid steel slag. The wall body is made of reinforced concrete, the high-temperature refractory layer is made of refractory bricks, and the baffle plate is made of a steel plate.

Further, the self-designed steel slag hot-steaming device is a cylindrical tank structure provided with a hot-steaming lid 8 on the top, a suspension device 11 in the middle, and a water drain hole 12 at the bottom; the side wall and bottom of the tank are provided, from the outside to the inside, with a wall body 1, a high-temperature refractory layer 2, and a baffle plate 3, where the baffle plate at the bottom is designed to be inclined to facilitate the discharge of wastewater, with an inclination angle of 5-20°; and a circular protruding ledge 4 is provided on the baffle plate of the side wall, and the suspension device 11 is placed on the protruding ledge 4.

Further, the inner center of the suspension device 11 is a semicircular tank made of reinforced concrete, the outer edge of the semicircular tank is uniformly connected to eight support rods along the circumferential direction, outer ends of the support bars are connected to a circular ring support, and the circular ring support is placed on the protruding ledge 4; and an end of the suspension device is approximately 80 cm from the top edge of the hot-steaming tank, and the diameter of the semicircular tank for the suspension device is 100 cm.

Further, the hot-steaming lid is provided with automatic spraying devices 9, an air release device 7, a safety valve 6, and an explosion-proof device 5, where the spraying devices 9 can realize automatic water spraying by using a sensor to sense the temperature within the device and a controller to determine whether to initiate spraying, and the spray devices spray water mist; the air release device 7 is provided to discharge a low-density explosive gas, such as H₂ and CO, generated during the slag hot-steaming process; and the safety valve 6 is provided to ensure the vapor pressure inside the tank and, if necessary, release the vapor pressure by discharging a medium outside the system when the pressure inside the device rises to exceed 0.4 MPa to prevent the pressure of the medium inside the device from exceeding a specified value.

The specific implementation process of the thermal activation of coal gangue and in-situ carbon fixation utilizing waste heat from steel slag according to the present disclosure will be described through the specific examples below:

### Example 1

The coal gangue was sampled from a coal preparation plant, the steel slag was converter steel slag from a steel plant, and the main chemical ingredients of the two materials were analyzed using X-ray fluorescence spectroscopy (XRF), as shown in Table 1.

TABLE 1
Main chemical ingredients of two raw
materials in Example 1 (wt. %)

| Ingredient | SiO₂ | Al₂O₃ | Fe₂O₃ | CaO | MgO | MnO | TiO₂ |
|---|---|---|---|---|---|---|---|
| Coal gangue | 58.27 | 33.82 | 1.69 | 0.82 | — | — | 1.16 |
| Converter | 12.22 | 2.42 | 24.40 | 51.24 | 5.74 | 2.12 | 0.62 |
| steel slag | | | | | | | |

The liquid steel slag from a converter of a steel plant was transported to a hot-steaming device, and then the liquid steel slag was poured in batches into the hot-steaming device using a crane; after each batch of steel slag was poured, water was manually sprayed; and once the surface of the steel slag solidified and developed numerous cracks, the steel slag was turned over with an excavator. The operations described above were repeated until the distance from the protruding ledge in the device was 48 cm and the temperature of the steel slag was 879° C.

The raw coal gangue was crushed using a jaw crusher, then ground using a ball mill, and sieved using a sieve mesh with a pore size of 0.18 mm. The coal gangue having a particle size of 0.2 mm or less after crushing and grinding was placed in a suspension device.

The sieved coal gangue was placed in the upper part of the hot-steaming device by means of the suspension device, the hot-steaming lid was covered, and the hot-steaming device was started. The reaction temperature was 500-850° C., the pressure in the device was 0.38 MPa, the reaction time was 2 h, and the automatic spraying devices on the hot-steaming lid sprayed water regularly, i.e. spraying water for 0.5 h and stopping spraying for 1 h, and then continuing to spray water for 0.5 h and then stopping spraying for 1.5 h. After the completion of hot-steaming, the activated coal gangue was removed, and the crushed and cooled steel slag was scooped out from the hot-steaming device using an excavator.

After a cooling treatment, the f-CaO in the steel slag was less than 3%, and the content of particles smaller than 20 mm in the treated steel slag reached 60% or more. The cooled steel slag was sent to a complementary system for iron and slag separation to recover the elemental iron in the steel slag. The cooled, crushed, and magnetically separated steel slag powder can be utilized as a concrete admixture in fields such as construction projects.

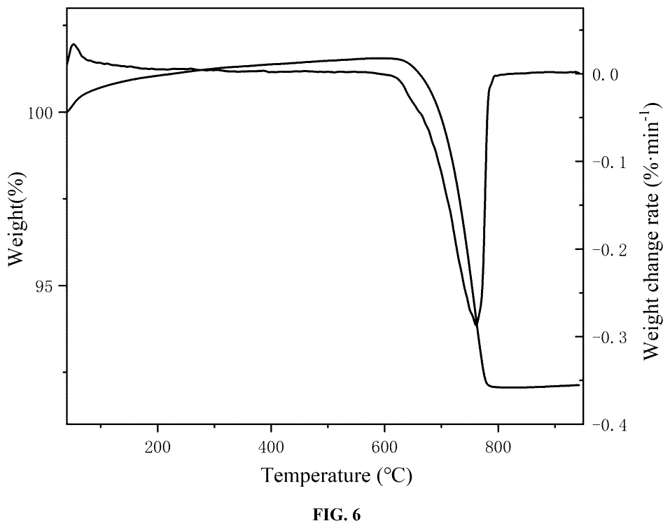

The mass loss of CO₂ in the steel slag after high-temperature carbon fixation was measured using a thermogravimetric analyzer. As shown in FIG. 6, according to the DTG curve, the decomposition temperature of CaCO₃ in the thermally activated coal gangue, as measured in the calorimeter, is approximately in a range of 600-822° C. The weight-loss ratio of the steel slag sample after carbon fixation in this temperature range was 9.48 wt. %, and the carbon fixation efficiency was 10.43 wt. %.

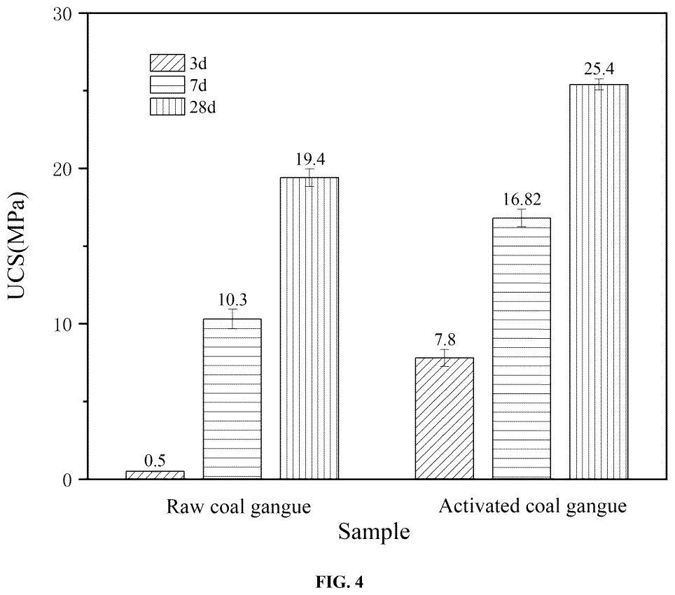

The activated coal gangue was mixed with cement to prepare concretion bodies, and the strength of the concretion bodies was used as an indicator of the pozzolanic activity thereof. The mechanical performance of cement mortar strength was tested in accordance with GB/T 17671-2021. The cement clinker accounted for 70% of the solid materials, while the thermally activated coal gangue accounted for 30%. The water cement ratio was 0.5. The compressive strength of the prepared paste concretion bodies was then tested. As shown in FIG. 4, the strength of the concretion body of the thermally activated coal gangue sample at 28 d was 25.4 MPa, which was 6 MPa higher than that of the non-thermally activated coal gangue sample at 28 d. The pozzolanic activity met the required standards.

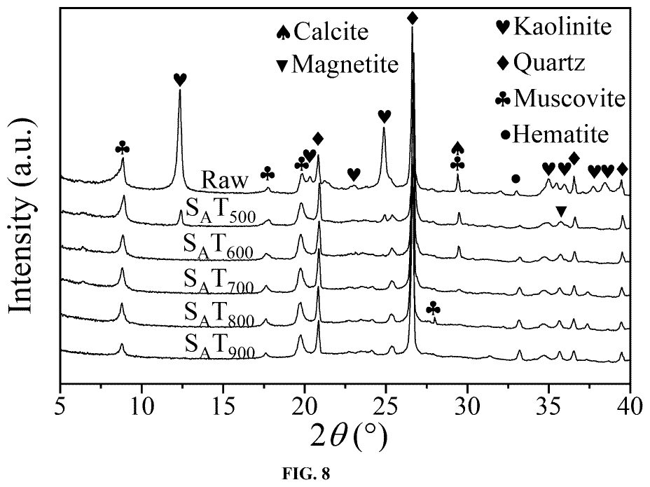

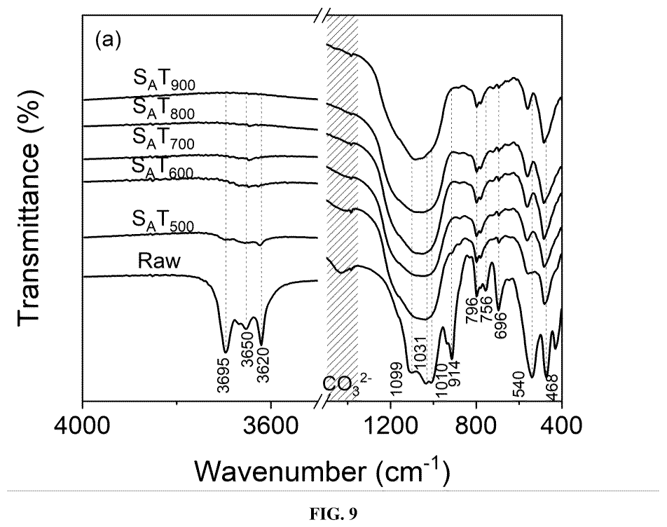

FIG. 8 and FIG. 9 show XRD and FTIR spectra of coal gangue after thermal activation at various temperatures under an air atmosphere, respectively. As can be seen from FIG. 8, The diffraction peaks of kaolinite at 2θ=12° and 24° have almost disappeared, indicating that the crystalline kaolinite (Al₂O₃·2SiO₂·2H₂O) in the coal gangue has transformed into amorphous metakaolin (Al₂O₃·2SiO₂). This transformation has led to a significant increase in the content of reactive Al₂O₃ and SiO₂. As can be seen from FIG. 9, after thermal activation, the absorption bands of coal gangue at 3695 cm⁻¹, 3650 cm⁻¹, and 3620 cm⁻¹ significantly decreased. This indicates that the crystalline kaolinite (Al₂O₃·2SiO₂·2H₂O) underwent dihydroxylation, losing both inner and outer hydroxyl groups, and transformed into a poorly crystalline transitional phase metakaolin (Al₂O₃·2SiO₂). Thus, a layered structure is transformed into a porous and disordered amorphous structure. After thermal activation, the absorption bands of coal gangue at 914 cm⁻¹ and 540 cm⁻¹ were significantly weakened, corresponding to the destruction of Al—OH and Si—O—Al bonds, respectively. The disappearance of the absorption bands at 1099 cm⁻¹, 1031 cm⁻¹, and 1010 cm⁻¹ was accompanied by the emergence of a new broadened absorption band. This is attributed to the depolymerization of the silicon-oxygen tetrahedral layers in kaolinite during the thermal activation process, leading to the formation of amorphous silicon. The absorption bands at 756 cm⁻¹, 696 cm-1, and 468 cm⁻¹ all showed varying degrees of weakening. These phenomena indicate the structural transformation of kaolinite into amorphous aluminosilicate compounds.

### Example 2

The coal gangue was sampled from a coal preparation plant, the steel slag was electric furnace steel slag from a steel plant, and the main chemical ingredients of the two materials were analyzed using X-ray fluorescence spectroscopy (XRF), as shown in Table 2.

TABLE 2
Main chemical ingredients of two raw
materials in Example 2 (wt. %)

| Ingredient | SiO₂ | Al₂O₃ | Fe₂O₃ | CaO | MgO | MnO | TiO₂ |
|---|---|---|---|---|---|---|---|
| Coal gangue | 58.27 | 33.82 | 1.69 | 0.82 | — | — | 1.16 |
| Electric furnace | 13.04 | 2.81 | 32.12 | 39.94 | 3.40 | 3.56 | 0.84 |
| steel slag | | | | | | | |

The liquid steel slag from a converter of a steel plant was transported to a hot-steaming device, and then the liquid steel slag was poured in batches into the hot-steaming device using a crane; after each batch of steel slag was poured, water was manually sprayed; and once the surface of the steel slag solidified and developed numerous cracks, the steel slag was turned over with an excavator. The operations described above were repeated until the distance from the protruding ledge in the device was 50 cm and the temperature of the steel slag was 893° C.

The raw coal gangue was crushed using a jaw crusher, then ground using a ball mill, and sieved using a sieve mesh with a pore size of 0.18 mm. The coal gangue having a particle size of 0.2 mm or less after crushing and grinding was placed in a suspension device.

The sieved coal gangue was placed in the upper part of the hot-steaming device by means of the suspension device, the hot-steaming lid was covered, and the hot-steaming device was started. The reaction temperature was 500-850° C., the pressure in the device was 0.35 MPa, the reaction time was 3 h, and the automatic spraying devices on the hot-steaming lid sprayed water regularly, i.e. spraying water for 0.5 h and then stopping spraying for 1 h, and then continuing to spray water for 0.5 h and stopping spraying for 1.5 h. After the completion of hot-steaming, the activated coal gangue was removed, and the crushed and cooled steel slag was scooped out from the hot-steaming device using an excavator.

After a cooling treatment, the f-CaO in the steel slag was less than 3%, and the content of particles smaller than 20 mm in the treated steel slag may reach 60% or more. The cooled steel slag was sent to a complementary system for iron and slag separation to recover the elemental iron in the steel slag. The cooled, crushed, and magnetically separated steel slag powder can be utilized as a concrete admixture in fields such as construction projects.

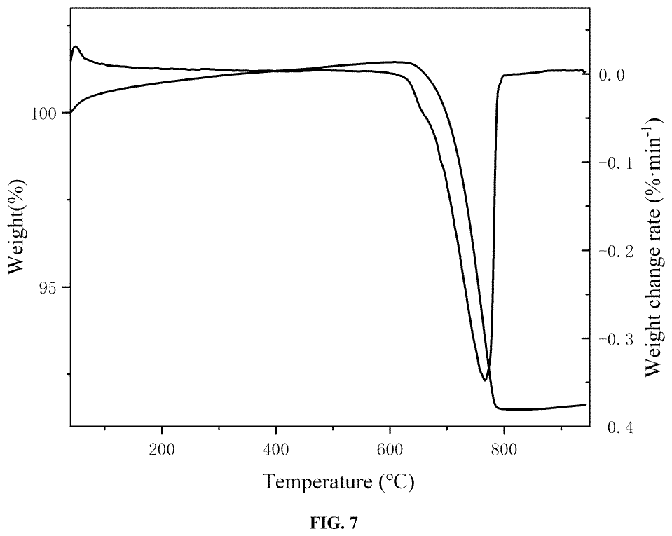

The mass loss of CO₂ in the steel slag after high-temperature carbon fixation was measured using a thermogravimetric analyzer. As shown in FIG. 7, according to the DTG curve, the decomposition temperature of CaCO₃ in the thermally activated coal gangue, as measured in the calorimeter, is approximately in a range of 604-815° C. The weight-loss ratio of the steel slag sample after carbon fixation in this temperature range was 9.95 wt. %, and the carbon fixation efficiency was 11.01 wt. %.

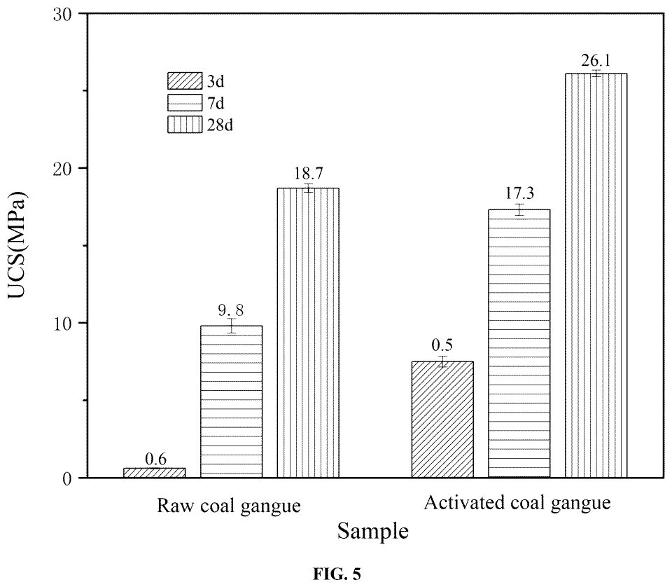

The activated coal gangue was mixed with cement to prepare concretion bodies, and the strength of the concretion bodies was used as an indicator of the pozzolanic activity thereof. The mechanical performance of cement mortar strength was tested in accordance with GB/T 17671-2021. The cement clinker accounted for 70% of the solid materials, while the thermally activated coal gangue accounted for 30%. The water cement ratio was 0.5. The compressive strength of the prepared paste concretion bodies was then tested. As shown in FIG. 5, the strength of the concretion body of the thermally activated coal gangue sample at 28 d was 26.1 MPa, which was 7.4 MPa higher than that of the non-thermally activated coal gangue sample at 28 d. The pozzolanic activity met the required standards.

What is claimed is:

1. A method for thermal activation of coal gangue and in-situ carbon fixation utilizing waste heat from steel slag, wherein by utilizing waste heat from high-temperature molten steel slag, coal gangue is activated to a high pozzolanic activity in a steel slag hot-steaming device utilizing the system temperature of the steel slag hot-steaming device, and meanwhile CO₂ released in the thermal activation process is captured utilizing the reaction of steel slag with CO₂ to generate stable carbonates to achieve permanent carbon sequestration.

2. The method for thermal activation of coal gangue and in-situ carbon fixation utilizing waste heat from steel slag of claim 1, comprising the following steps:
step 1: transporting high-temperature liquid steel slag from a converter to a hot-steaming device by a slag pot carrier, and pouring the liquid slag in batches into the steel slag hot-steaming device using a crane;
step 2: crushing and grinding raw coal gangue, and loading the crushed and ground coal gangue into a suspension device;
step 3: placing the suspension device loaded with coal gangue into the hot-steaming device and covering a hot-steaming lid for a slag hot-steaming treatment for 2-3 h with a reaction temperature of 500-850° C., a pressure of 0.3-0.4 MPa, and spraying devices automatically spraying water, wherein the coal gangue undergoes a thermal activation reaction, and meanwhile, the steel slag undergoes a carbonation reaction with CO₂, thereby capturing CO₂ generated during the activation process of coal gangue; and
step 4: after the completion of the hot-steaming process, removing the activated material, and scooping out the crushed and cooled steel slag from the hot-steaming device using an excavator and transporting the steel slag to a subsequent iron and slag separation system.

3. The method for thermal activation of coal gangue and in-situ carbon fixation utilizing waste heat from steel slag of claim 1, wherein in step 1, the steel slag hot-steaming device is a cylindrical tank structure provided with a hot-steaming lid on the top, a suspension device in the middle, and a water drain hole at the bottom; the side wall and bottom of the tank are provided, from the outside to the inside, with a wall body, a high-temperature refractory layer, and a baffle plate, wherein the baffle plate at the bottom is designed to be inclined to facilitate the discharge of wastewater, with an inclination angle of 5-20°; and a circular protruding ledge is provided on the baffle plate of the side wall, and the suspension device is placed on the protruding ledge.

4. The method for thermal activation of coal gangue and in-situ carbon fixation utilizing waste heat from steel slag of claim 3, wherein the inner center of the suspension device is a semicircular tank made of reinforced concrete, the outer edge of the semicircular tank is uniformly connected to 8 support rods along the circumferential direction, outer ends of the support bars are connected to a circular ring support, and the circular ring support is placed on the protruding ledge; and an end of the suspension device is approximately 80 cm from the top edge of the hot-steaming tank, and the diameter of the semicircular tank for the suspension device is 100 cm.

5. The method for thermal activation of coal gangue and in-situ carbon fixation utilizing waste heat from steel slag of claim 3, wherein the wall body is made of reinforced concrete, the high-temperature refractory layer is made of refractory bricks, and the baffle plate is made of a steel plate.

6. The method for thermal activation of coal gangue and in-situ carbon fixation utilizing waste heat from steel slag of claim 3, wherein the steel slag hot-steaming lid is provided with automatic spraying devices, an air release device, a safety valve, and an explosion-proof device, wherein the spraying devices can realize automatic water spraying by using a sensor to sense the temperature within the device and a controller to determine whether to initiate spraying, and the spray devices spray water mist; the air release device is provided to discharge a low-density explosive gas generated during the slag hot-steaming process; and the safety valve is provided to ensure the vapor pressure inside the tank and, if necessary, release the vapor pressure by discharging a medium outside the system when the pressure inside the device rises to exceed 0.4 MPa to prevent the pressure of the medium inside the device from exceeding a specified value.

7. The method for thermal activation of coal gangue and in-situ carbon fixation utilizing waste heat from steel slag of claim 2, wherein when pouring the steel slag into the hot-steaming device using the crane, after pouring each batch of the steel slag, using the excavator to turn the steel slag over and break up large slag chunks, and at the same time, manually spraying an appropriate amount of water for cooling; and after the slag surface becomes solidified, repeating the operations described above, and stopping the distribution of slag until the distance from the protruding ledge in the hot-steaming device is 45-50 cm, and the temperature of the steel slag is 850-900° C.

8. The method for thermal activation of coal gangue and in-situ carbon fixation utilizing waste heat from steel slag of claim 2, wherein the raw coal gangue is treated as follows: crushing the raw coal gangue using a jaw crusher and then grinding the raw coal gangue with a ball mill, and sieving the raw coal gangue using a sieve mesh with a pore size of 0.18 mm, wherein the particle size of the coal gangue after crushing and grinding should be 0.2 mm or less; loading the sieved coal gangue into the suspension device, which is connected and fixed to the upper protruding ledge of the hot-steaming device, to suspend the coal gangue in the upper part of the hot-steaming device; and activating the coal gangue to stimulate the pozzolanic activity thereof utilizing the heat in the hot-steaming device system.

9. The method for thermal activation of coal gangue and in-situ carbon fixation utilizing waste heat from steel slag of claim 2, wherein the water spraying procedures of the automatic spraying devices during hot steaming are as follows: spraying water for 0.5 h and then stopping spraying for 1 h, and continuing to spray water for 0.5 h and then stopping spraying for 1.5 h, wherein a water spraying pressure is 0.25-0.35 MPa, and a flow rate is 15-30 m³/h.

10. The method for thermal activation of coal gangue and in-situ carbon fixation utilizing waste heat from steel slag of claim 2, wherein in the treated steel sage, f-CaO is less than 3%, and the content of particles smaller than 20 mm reaches 60% or more.
